(19) United States
(12) Patent Application Publication
(10) Pub. No.: US 2011/0208759 A1
(43) Pub. Date: Aug. 25, 2011

(54) Method, Apparatus, and Interface For Creating A Chain of Binary Attribute Relations

(75) Inventor: Paul Zellweger, Rochester, MN (US)

(73) Assignee: Paul Zellweger, Rochester, MN (US)

(21) Appl. No.: 12/711,215

(22) Filed: Feb. 23, 2010

(51) Int. Cl. G06F 17/30; G06F 3/048; G06F 9/44

(52) U.S. Cl. 707/754; 715/762; 707/755; 717/120; 707/E17.095; 707/E17.059

(57) ABSTRACT

The present invention improves upon the authoring system for a content menu by disclosing a new interface and program control which enables a menu developer to create and to capture meta-query data in the form of a chain of Binary Attribute Relations. The Binary Attribute Relation or BAR represents a pair of attributes which serve as meta-query data for a primitive retrieval operation known as a BAR query. The BAR query exposes a primitive data relation in an external data file which forms a basic building block for the content menu. Recursive algorithms parse the BAR chain to create network segment of data and data relations to automatically create a knowledge representation known as a “database taxonomy”. The pairing of two attributes in a BAR link and the sequence of these links in a BAR chain adhere to a well-defined system of rules. The present invention embeds these rules in the developers' interface to guide the developer in capturing a series of meta-query data by highlighting the relevant elements of the logical structure of a data file as options, and by filtering out the irrelevant ones. Program control associated with this new interface captures the selections made by a developer and employs them to generate either runtime or compiled menu data for the content menu automatically.

References Cited

| | | |
|---|---|---|
| 12/707,674 | Feb. 18, 2010 | Zellweger |
| 61/154,947 | Feb. 24, 2009 | Zellweger |
| 6,301,583 | Oct. 9, 2001 | Zellweger |
| 6,279,005 | Aug. 9, 2001 | Zellweger |
| 6,243,700 | Jun. 5, 2001 | Zellweger |
| 6,131,100 | Oct. 10, 2000 | Zellweger |
| 6,131,098 | Oct. 10, 2000 | Zellweger |
| 6,061,692 | May 9, 2000 | Thomas, et al. |
| 5,664,173 | Sep. 2, 1997 | Fast |
| 5,630,125 | May 13, 1997 | Zellweger |

### LITERATURE REFERENCES

Atzeni, Paulo, Stefano Ceri, Stafano Paraboschi and Riccardo Torlone. Database Systems, Concepts, Languages, and Architectures. Berkshire, England: McGraw-Hill Publishing Company, 2000, pp. 21-22.
Biggs, Norman. Discrete Mathematics. Oxford, England: Oxford University Press, 1996, p. 194.
Codd, E. F. A Relational Model of Data for Large Shared Data Banks Communications of the ACM, 13(6), 1970, pp. 377-387.
Codd, E. F, Extending the Database Relational Model to Capture More Meaning, ACM Transactions on Database Systems, 4(4), 1979, pp. 397-434.
Knuth, Donald. The Art of Computer Programming, v. 2: Seminumerical Algorithms, Boston, Mass.: Addison-Wesley, 1997, p. 348.
Zellweger, Paul. A Database Taxonomy Based On Data-Driven Knowledge Modeling. (IEEE) KIMAS'05 Waltham, Mass., pp. 469-474.

### BACKGROUND

1. Field

This application relates to an end-user interface to a database system, and specially to its automated construction.

2. Prior Art

Zellweger (U.S. Pat. No. 6,131,098) introduced a pioneering way to navigate over database content and to access its content with the database taxonomy, a knowledge representation of data and data relations that can be viewed from an end-user navigation structure known as a content menu. This new technology is rooted in the open hierarchical data structure (OHDS), a list of nested overlapping topic lists, first described by Zellweger (U.S. Pat. No. 5,630,125) in 1997. Initially, this structure served as a conduit between the mapping of data and data relations found in a database and the menu data for the content menu. When this structure was complete, it provided the framework for generating a series of menu data files, where each file represented a segment of the OHDS. Over the past decade, improvements to the content menu, described throughout multiple disclosures made by Zellweger, including U.S. Pat. Nos. 6,243,700 & 6,301,583 on hypertext and applets, have been made.

Early on, Zellweger showed how to employ interactive menus and specialized software to automatically generate a network of topic paths in the OHDS from existing database content. The developer would use the interface disclosed in U.S. Pat. No. 6,131,100 to navigate over the target database, and to select database and file fields for as sources for mapping of data and data relations into the OHDS. Commands in this interface enable the developer to logically link data-topics in one table or file with data-topics from another table or file based on attribute or field locations. Program control associated with this interface would formalize this logical construction in a symbolic expression. Software in U.S. Pat. No. 6,279,005 would parse this expression to extract data lists, which were added algorithmically to the OHDS as a network of data-topic lists and paths. In a more recent disclosure made by Zellweger (U.S. Pat. No. 6,131,098), innovative back-end algorithms would parse this symbolic expression to extract meta-query data, and store it in its own database, in order to generate a list menu in the content menu at runtime.

The ability to encode attribute relationships in a predefined symbolic expression was, at the time, an important discovery. First and foremost, it proved in a very tangible way that Codd's argument against considering binary attribute relations in the database table as being limited to database design issues (p. 423). From an operational perspective, the binary attribute relations in this expression contained meta-query data, which was responsible for extracting data-topics, and for serving as a common symbolic language between front- and back-end processes in the authoring system, thereby enabling any number of different front-end processes to communicate with any number of back-end components. And this enabled a developer to hand type a symbolic expression which the authoring system could translate into a network of data-topics in the OHDS automatically. More recent improvements to this symbolic expression include a more compact form of meta-query data based on the Binary Attribute Relation or BAR, which provides a higher level of system integration, thereby making it easier to maintain, among other noted benefits in Ser. No. 12/707,674.

The current disclosure improves upon these prior disclosures in three crucial ways: 1.) by reformulating the original attribute expression, a new improved symbolic expression was discovered—the BAR chain, 2.) along with the discovery of this new symbolic expression came the discovery of a new set of properties and rules concerning its construction, and 3.) with these new properties and rules, a host of new improvements could be made to the developers' interface and to the mapping algorithms which generate menu data for the content menu. Perhaps, the most significant advance here can be seen by viewing the BAR chain as a new type of conceptualization, one which reduces the complexity of data and data relations in the database, by introducing a radical new way to model them symbolically using meta-query data.

When parsing the original attribute expression for meta-query data in U.S. Pat. No. 6,131,098, the working concept for a BAR eventually became evident, as a primitive retrieval operation, identified by the inventor as a BAR query, could generate menu data for a runtime list menu, consisting of single input and output channels. The discovery of the BAR and the BAR query was first disclosed in 61/154,533 on Feb. 23, 2009.

The BAR chain, disclosed in the present specification, expands upon the algebra of the BAR, by referring back to each BAR as a link, and by looking in a forward direction to its own construction to expose its rules that can be abstracted and generalized. This discovery led Zellweger to reformulate the original attribute expression taught by U.S. Pat. No. 6,279,005, and to consider the impact of this new symbolic expression on how the developers' interface captures meta-query data, and how the authoring system employs this meta-query data to extract raw data from a database to create list menus.

With the properties and rules in place on how to build a BAR chain, and with its immediate correspondence to meta-query data, advances to the developers' interface, to the mapping algorithms, and to the procedures in the authoring system could be made. By making the meta-query data more compact and more tightly integrated, these advances improve the authoring system's functionality and maintainability. For instance, by capturing meta-query directly from the developers' interface, as taught by this disclosure, this new approach streamlines the work flow between the front-end and back-end processes by completely eliminating the need to build a symbolic expression, and then parse it, by storing the meta-query immediately.

The most significant improvement brought about by the discovery of the BAR chain is that it enables the new developers' interface disclosed by this invention to actively help end-users navigate over a target database. With the rules on the BAR chain, and on the pairing of attributes in each link well understood, this new interface is now able to display only valid options and to filter out any unnecessary or irrelevant ones, something which was missing in the prior interface art, which, as one would expect, could only be used by experts. This new, guided-navigation capability lowers the degree of technical training and know-how required to use this menu-authoring tool, effectively broadening its intended overall audience to include nontechnical professions.

Other recent disclosures focus on the generation of meta-data, specifically U.S. Pat. Nos. 6,061,692 and 5,664,173. In U.S. Pat. No. 5,664,173 Fast teaches how to employ meta-data for an information server that has a hierarchical order. However, this meta-data refers to content information, application information, and configuration information; it does not refer to meta-data responsible for extracting menu data from a database for creating an end-user access method like the applicant's content menu. Thomas et. al in U.S. Pat. No. 6,061,692 teaches how to generate meta-data for test systems that verify query syntax. Therefore, neither one of these recent disclosures focuses on the art of modeling the data and data relations in a database for an end-user database interface, the inventor's domain.

### DRAWINGS—BRIEF DESCRIPTION OF THE FIGURES

FIG. 1 depicts the prior art of a content menu, a database interface on a client computer that organizes database content into a type of knowledge representation that is identified by the inventor as a “database taxonomy.”

FIG. 2 depicts the client server network apparatus of the present invention.

FIG. 3 depicts the major software components of the prior content menu: an authoring system that generates menu data files, the menu data files, and a client browser that displays these files in a content menu.

FIGS. 4a though 4c depict an example of a target database system composed of three table structures that is used to demonstrate the new art.

FIG. 5 depicts the prior art of the open hierarchical data structure that organizes data and data relations in a target database system for the prior art of the content menu.

FIG. 6 depicts the database structure of the prior OHDS art.

FIGS. 7a through 7c depict the developers' interface of the prior art used to generate a coded expression which eventually yields meta-query data used to construct the open hierarchical data structure.

FIGS. 8a and 8b depict an overview of the program flow of capturing meta-query data in the new and prior art.

FIGS. 9a and 9b depict the file format of the new and prior art of meta-query.

FIGS. 10a and 10b display the Binary Attribute Relation or BAR and its relationship to a chain of interrelated binary attributes or BAR chain, the new art disclosed by this invention.

FIGS. 11a through 11e depict a navigation sequence of the new developers' interface which follows the properties and rules which govern the construction of a BAR chain.

FIGS. 12a and 12b show the correspondence between a sequence of menus in the new developers' interface and its meta-query data, from the perspective of the BAR chain and the storage structure which manages this data.

FIG. 13 depicts the architecture and new software components of the client server apparatus of the present invention.

FIGS. 14a through 14d depict an overview of the program flow of the new developers' interface and the software components which use meta-query data to generate menu data for the compiled and runtime content menus.

### NUMERICAL REFERENCES

5—content menu system
6—list menu in a content menu system
10—list menu header
11—data-topic list in list menu
12—binary attribute data relation
15—sever computer
17—client computer
27—content menu authoring system
28—menu data file
30—browser software
35—sample database
68—open hierarchical data structure (OHDS)
104—database table representing the OHDS
112—prior developers' interfaces
128—meta-query data storage structure
130—new developers' interface
145—binary attribute relation (BAR) in notation
150—a chain of binary attribute relationship (BAR chain)
150s—short form of BAR chain
260—program flow for capturing meta-query data
264—program flow for building OHDS
266—program flow for building compiled menu data files
268—program flow for building runtime menu data file

### DETAILED DESCRIPTION

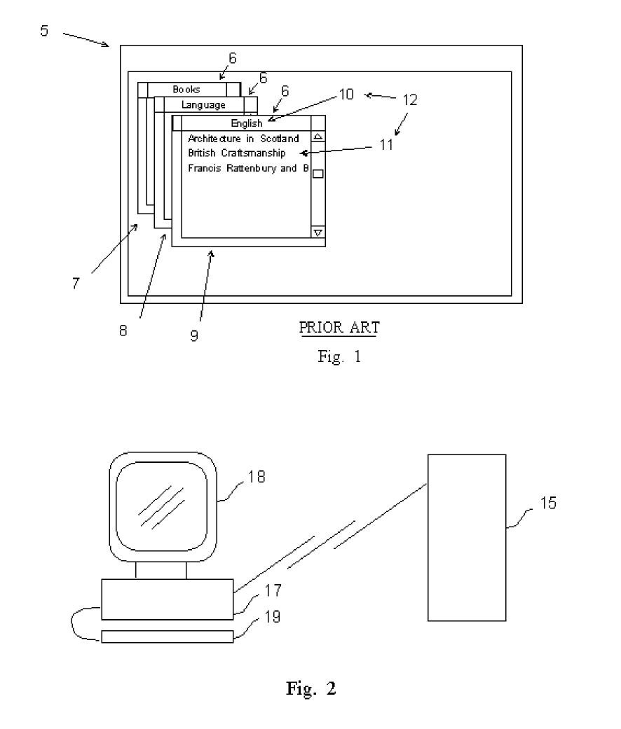

An embodiment of the end-user database interface that is known as a content menu 5 is depicted graphically in FIG. 1. Graphical user interface (GUI) 5 consists of one or more nested topic list menus 6 that display the data and data relations in a database as a list of nested data-topic lists. The structure of the data-topic content in GUI 5 represents a knowledge representation identified here by the inventor as a database taxonomy. Each list menu 6, like 7, 8, and 9 in 5, consists of a list menu header 10—a topic selected by the end-user in the previous list menu, in this case menu 8—and one or more related topic items in a scrolling list display like region 11 in 9.

The relationship between header topic 10 and the list 11 of related topics in content menu 5 is significant, because it represents data relation 12, something which occurs naturally in a database structure. That is, when both header topic 10 and list 11 are derived from raw data in a database, and neither contains a constructed-topic or something that was added by hand.

Data relation 12, introduced and presented in detail by 61,154,533 as Binary Attribute Data Relations or BADR, signifies an extremely important discovery about the nature of data-symbols on a computer and about the type of data relations this mechanical device creates. More to the point, data relation 12 occurs naturally in other data models, storage structures, including in RDF files, data structures, and even in computer files that have field and record structures (including both fixed and variable length field), when it is viewed from the perspective of a primitive retrieval operation like the BAR query.

In FIG. 1, data relation 12 represents a “one-to-many” relationship between two pools of data. In content menu 5, this logical relationship is invariant, as the selected item in list menu 8, the ONE, semantically relates to data-topics in list 11 as MANY. This data relation 12 can also represent a “one-to-one” relationship, as it can also occur naturally between two pools of data, making 12 difficult to identify and view, until now. In the present invention, data relation 12 is fundamental to this disclosure because it expresses, both symbolically as well as operationally—that a BAR algebraically and as meta-query data represents a BADR. This topic that will be expanded upon in detail shortly as this disclosure focuses on a BAR chain which expresses a complete network of such data relations.

In content menu 5, each time an item in 11 is selected by an end-user, this technology generates a new data-topic list menu 6 which narrows or refines the most recently selected topic according to the logical relations exposed by the BAR and its BAR query. At the end of each menu path, content menu 5 displays an information object window that furnishes information drawn from a unique record in the database. The linkage between this succession of list menus 6 and an information object window is based on an embedded primary key which terminates the BAR chain.

Alternative embodiments of the content menu include navigation structures or graphical interfaces that represent such menu paths or nested topic lists in a tree-view interface in an applet (U.S. Pat. No. 6,301,583) or in nested hypertext lists (U.S. Pat. No. 6,243,700). Embellishments to the preferred and alternative embodiments of these navigation structures include graphic icons and sound clips as topic entries.

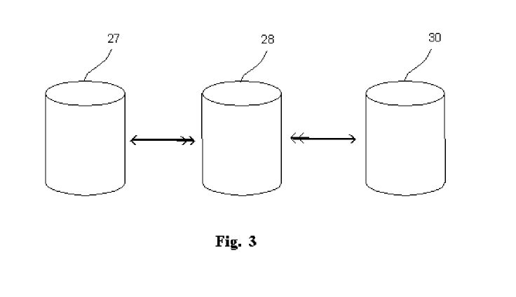

The client server network apparatus of the present invention is depicted in FIG. 2. A client computer 17 is electronically linked to server computer 15. This linkage includes any combination of physical cabling and wireless connections. Server 15 is responsible for providing the menu data for the content menu 5 displayed on monitor 18 of client 17. Client 17 has communications software that enables it to request menu data from server 15. An end-user on client 17 employs an input device like keyboard 19 on 17 to make a selection in content menu 5 and or to input text in order to use and navigate 5.

Alternative input devices on client 17 include touch-screens, pointing devices like a mouse, voice-activated systems, and other types of sensory-input devices that would enable an end-user to make selections in content menu 5. The monitor 18 of 17 displays content menu 5 visually as a graphic image; alternative output devices include “talking software” systems that would enable an end-user to receive auditory descriptions of the content menu.

Alternative embodiments to the network configuration of the present invention include a stand-alone computer where the menu data associated with content menu 5 resides on a local data storage device. Alternative embodiments to the stand-alone computer or to the client computer 17 also include any computing device, regardless of its size or sensory interaction, which communicates with an end-user by presenting information requested by that end-user.

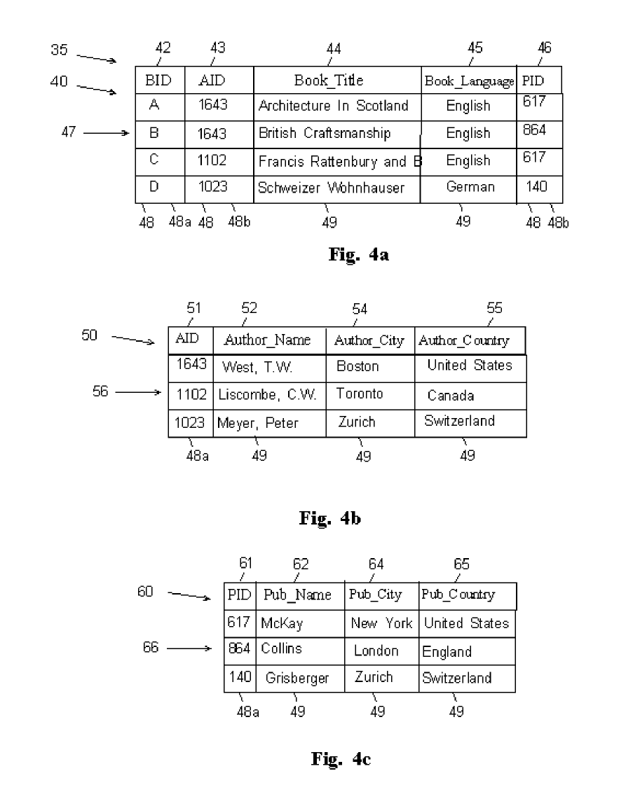

The major software components of the prior art of the content menu 5 are graphically depicted in FIG. 3. One software component of this prior art is an authoring system 27 that generates menu data files 28 for content menu 5. These menu data files 28 are processed by browser software 30 on client 17 to create content menu 5.

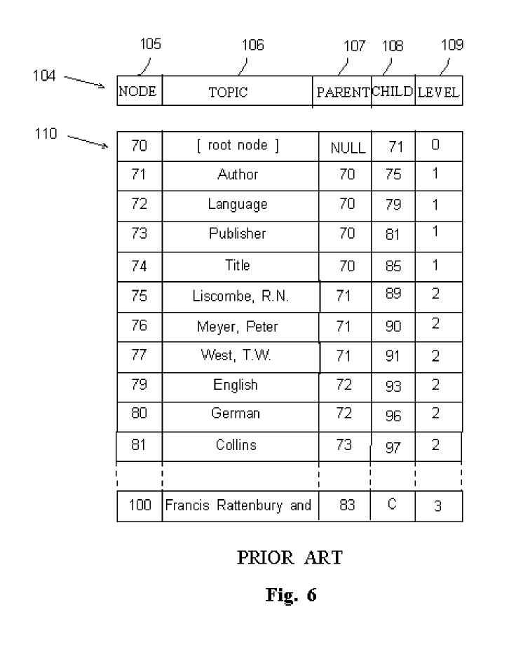

In the prior art, authoring system 27 builds and maintains an open hierarchical data structure or OHDS that organizes menu data into a single, unified data structure. The structure and organization of OHDS 68 will be presented in FIG. 5. In the prior art, authoring system 27 employs OHDS 68 to generate a series of compiled files 28 for content menu 5, with each menu data file 28 corresponding to a mutually exclusive network segment of OHDS 68. In this setting, browser software 30 on 17 requests a specific menu data file 28 over the network and parses the contents of file 28 in order to generate one or more list menu 6 in 5. Software tools in this new art enable a menu data file 28 to be built on demand at runtime or compiled at a prescribed time.

In the new art, authoring system 27 contains a developers' interface that enables the developer to capture meta-query data from an external database system based on the properties and rules of the BAR chain, the subject of this new art. It guides the developer in navigating over an external database, by only offering options that are consistent with the rules that govern the formation of the BAR chain.

In the preferred embodiment of the present invention, authoring system 27 resides on server 15 and it maintains menu data files 28 and meta-query data on there as well. In the alternative embodiments of the present invention, say on the standalone system configuration, where both the target database and the browser software 30 reside on the same computer, authoring system 27 can reside on the same machine along with the target database and with software 30, or 27 can connect to either one over the network. In this setting, authoring system 27 can maintain menu data files 28 and the meta-query data on this same computer or on any other computer that 27 can establish connections with. In other words, authoring system 27, menu data files 28, meta-query data, and the target database files can reside anywhere in a connected network.

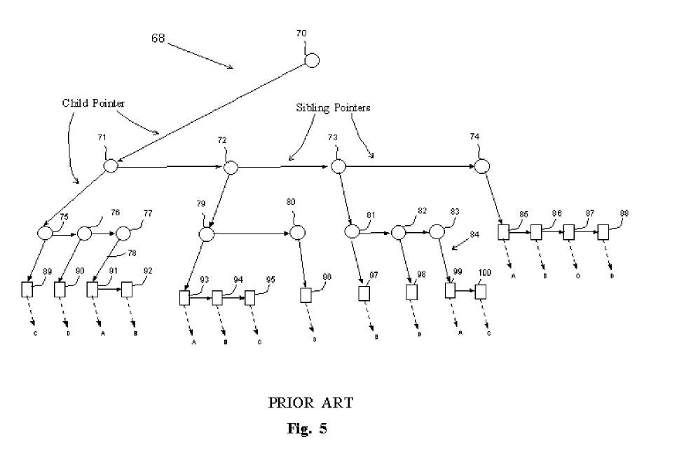

To demonstrate the present disclosure, as well as to refer to the prior art, a relational database of an inventory of books will be used as an example. This example, target database 35, consists of three database tables or entities: Book_Desc 40, Authors 50, and Book_Pub 60, which are depicted in FIGS. 4a through 4c.

Each row or entry in Book_Desc 40, depicted in FIG. 4a, represents a book, such as 47, managed by this book inventory management system. Or, in relational database terms, each row in 40 represents an instance of an entity. That is, each book entry in 40 has data which corresponds to its title, Book_Title 44, its inventory system identification number, BID 42, and the language with which the book was written, Book_Language 45. Other, related information about each book—in accordance with the relational model—is contained in different tables or entities, such as Authors 50 and Book_Pub 60 tables as they have a one-to-many relation to Book_Desc 40, the primary entity.

At this point in the discussion, it is important to point out that the relational table is a two-dimensional logical structure consisting of columns, fields, or attributes and rows, records, or tuples. In strict relational database terms, these dimensions are “attributes” and “tuples.” However, sometimes the terms “attribute” and “columns”—and even “fields”—are used interchangeably to describe the vertical dimension of this logical structure, and the terms “rows” and “tuples”—and sometimes even “records”—are also used interchangeably to describe its horizontal dimension.

Some columns or attributes store data values that describe the entity, like Book_Title 44 in 40 or Author_Name 52 in 50. Other attributes serve as value-based links between two tables, such as AID 51 in 50, a primary key, and AID 43 in 40, its operational counter, a foreign key. These two keys give the relational model its value-based navigation capabilities, which are universally recognized by the database research community, and which are described by Atzeni et al, as links “between one table and another at the row level”, (p. 21-22).

In this new database interface art, the functional distinction between attributes that manage data that describe an entity versus attributes whose data links one table to another is critical to the understanding of the rules that govern the formation of the BAR chain, and its links, the BAR. Attributes which are declared as primary and foreign keys in the schema, or used that way, are identified in this new art as operational attributes or 48. Furthermore, a primary key or 48a represents a specific type of key, which refers to a unique tuple or row in a database table. From this perspective, the foreign key or 48b represents a link to that row from another table, giving these two different types of keys a complementary relationship to each. Together, foreign key 48b and primary key 48a are responsible for the value-based linkage at the row level between two logically connected tables. All other attributes in a table, by default, are considered by the inventor to be conceptual attributes; that is, they manage data that describes something about an entity.

This distinction between operational attributes 48 and conceptual attributes 49 will be made throughout this disclosure, to signal its singular importance over the prior art, which did not make such a distinction. Codd, in his seminal 1970 ACM paper that introduced the relational model, addressed this distinction, but only in a very general way that, until now, has had absolutely no consequence on our understanding of data relations from an attribute pairing perspective. This area remains unchartered, until now. The present disclosure, along with an earlier one made by Zellweger on the BAR and the BAR query (61/154,533 Feb. 23, 2009), is able to show in a very concrete way how these two different types of attributes contribute to the rules on pairing attributes in a BAR and their impact on the different types of binary attribute data relations.

A graphic representation of the prior art of the open hierarchical data structure or OHDS 68, a. k. a. the K2Structure, is depicted in FIG. 5. The organization of OHDS 68 is somewhat similar to the LEFT child—RIGHT sibling structure described by Knuth (p. 348). However, to build and maintain something that organizes menu data for content menu 5 requires that this new structure have its own interactive, graphical user interface and—more importantly—that its paths overlap. This interactive capability allows developers to merge data-topics, which are extracted from an external database 35, with constructed-topics, added by hand, to ease the transition from one set of data-topics to another. Together, these two different types of menu topics give shape and form to the knowledge representation Zellweger identifies as a “database taxonomy,” and all this goes well beyond the simplicity of the data structure described by Knuth, which is used only narrowly as a memory management tool.

In many respects, the OHDS actually represents two different structures, depending upon your perspective. In memory, its elements: nodes and edges, conform somewhat in a general way to the data structure described by Knuth. This image of the OHDS is a static or single-dimensional view. However, when its labeled nodes are viewed through the aperture of a content menu GUI, the structure of its labeled nodes and their edges almost comes to resembles a hypergraph, where the downward flow from one labeled parent node reveals any number of siblings. This picture represents a dynamic view of a structure, which is entirely based on an outside agent making a selection. For simplicity sake, this disclosure will focus on the former.

As mentioned above, OHDS 68 consists of nodes and edges. Each node is labeled, either by a data-topic or a constructed-topic; each label serves as a menu item in 5. Flow in 68 starts at root node 70 and continues downward through one or more branch nodes, like 71 or 72, to a leaf node, such as 89 or 92, at the bottom of the digraph. Below the root, each node has two different edges: sibling and child pointers; they are deployed in the construction of nested list menus 6 in GUI 5.

A sibling pointer, like the one on node 93, establishes a list of menu topics that correspondences to items in list menu 6, like region 11 in 9. Each node in 68 has a child pointer that gives this structure its distinctive hierarchical flow. This pointer links each menu topic in list menu 6 to a successor list 6. The flow created by a succession of child pointers represents a hyper-path. At the end of each hyper-path in 68, the leaf node refers to an embedded primary key 48a, like 89 or 93, which is responsible for linking content menu 5 with an information object window, and for its tuple-based construction.

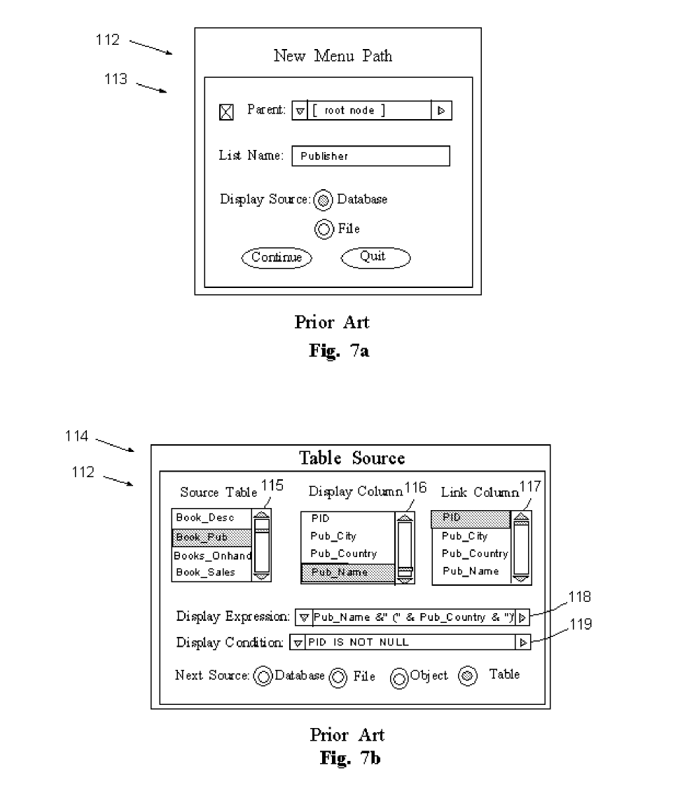

The OHDS 68 is stored in database structure 104, depicted in FIG. 6. Authoring system 27 builds and manages database 104 in order to compile one or more menu data in files 28 for content menu 5. Each node in 68 is represented by a record or tuple. Attributes in 104 store information on each node, such as its TOPIC character string in 106 and its numeric identifier in NODE 105. Alternative embodiments of structure 68 include predetermined file formats, as well as other types of database architectures or file structures.

Once structure 68 is built and captured in structure 104, authoring system 27 navigates its hierarchical data, PARENT 107, CHILD 108, and LEVEL 109, to segment 68 into mutually exclusive divisions, which are then compiled into one or more menu data files 28 for the content menu 5. An alternative embodiment of compiled menu data file 28 is the menu data file 28 that is built at runtime using meta-query data to extract “live” data and data relations from target database 35.

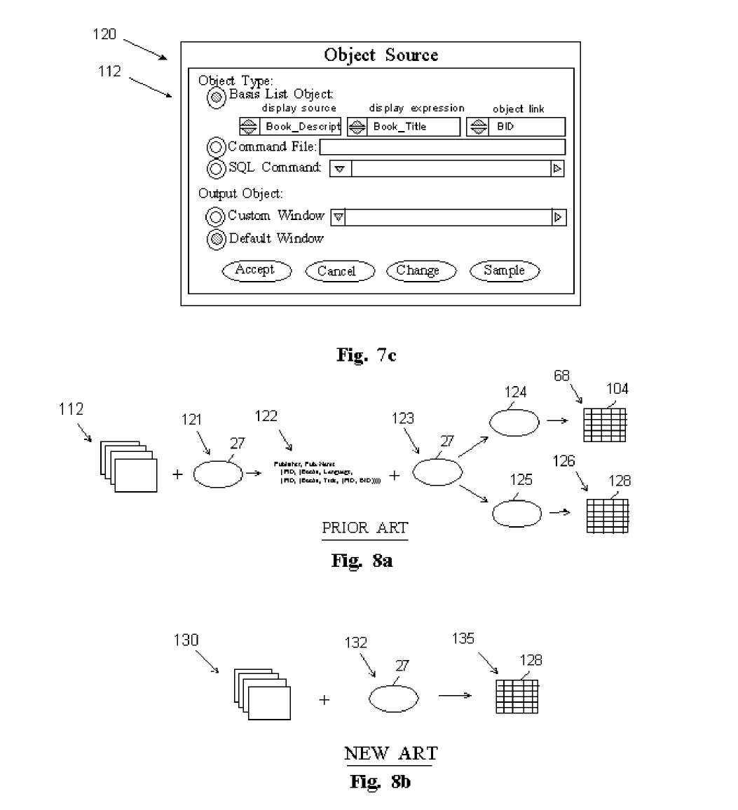

FIGS. 7a through 7c depict the prior art of developers' interface 112 in 27. In this prior art, developers navigate over a target database schema, like 35, or a data file to select a sequence of attributes or fields that corresponds to a sequence of meta-query data. In this prior art, authoring system 27 would transform this sequence of meta-query data into a nested expression, which would then be used to extract data and data relations in 35 in order to populate the nested data-topic lists in 68. In more recent disclosures, this nested expression furnished meta-query data for generating menu data for runtime list menu 6 in 5.

In this prior interface art, the menu developer of 5 would start with New Menu Path 113, depicted in FIG. 7a. In this menu, the developer would declare a new data-topic network and link to database 104 by selecting a node in 68 as a parent node. Next, the developer specifies the external source for menu data by selecting the Database or File radio button. Menus in interface 112 create views on the structural organization or schema of an external database, or, in the case of a file, its field-based record content, thereby enabling the developer to select attributes or fields that can serve as sources of menu data. After selecting the Continue push button in 113, the next interactive menu in the navigation sequence appears.

When the Database button in 113 is selected, interface 113 steps the developer through a series of menus that connect to external database 35 in order to establish access to its schema. The next menu in this sequence displays Table Source menu 114, depicted in FIG. 7b. Menu 114 enables the developer to select a table in database 35 in 115, from a scrolling list of table names. When a selection is made, Display Column scrolling region 116 and Link Column 117 display the selected table's attributes, allowing the developer to make additional selections. Attribute items in 116 furnish data-topics for a list menu 6 in 5, and attributes in 117 provide the link values between these data-topics and the next Display Column selection. In 114, the developer can provide an output format for the data-topics at 118, and in 119 he or she can add any selection conditions to their retrieval operation.

To build a network segment of data-topics, the developer navigates from one Table Source menu 114 to another by selecting the Database radio button in the Next Source group of 114 and by repeating this process until the Object button in 114 is selected. Data-topics associated with Display column 116 in one 114 are logically linked with the data-topics in the next by authoring system 27. Program control in 112 translates the Display and Link Column selections made in one menu 114 into embedded clauses of the symbolic expression of the prior art. When the developer selects the Object button as the Next Source, authoring system 27 presents the Object Source menu 120 depicted in FIG. 7c. In menu 120, the developer selects an attribute (or a set of attributes) which serves as a primary key 48a, and then program control associated with the prior art of 112 generates its nested symbolic expression, which, after system verification and the end-user's confirmation, is based on the sequence of attribute selections made by the developer.

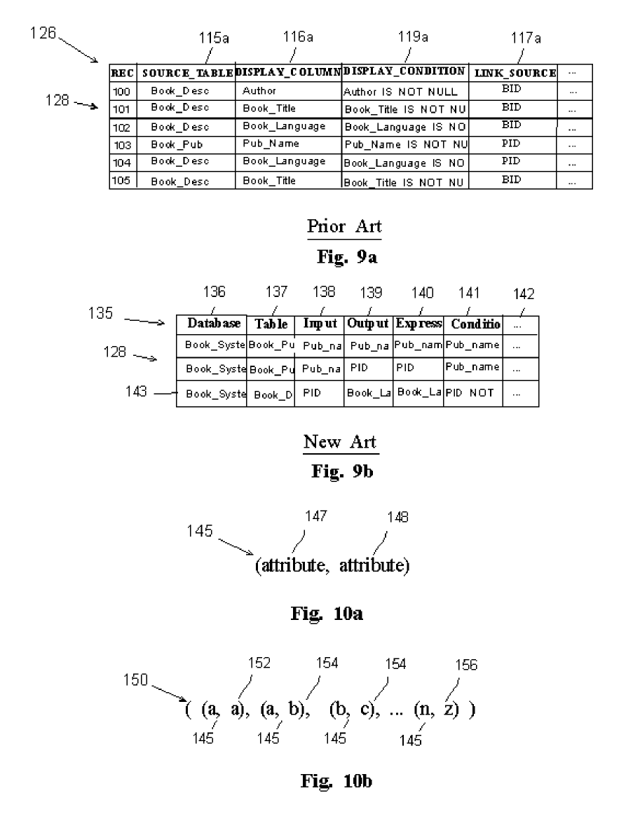

The relationship between the developers' interface and the meta-query data in the new and prior art is depicted in FIGS. 8a and 8b. In the prior art of 112, the program flow of meta-query data is graphically shown in FIG. 8a. First, front-end algorithms 121 in 27 generate a nested symbolic expression 122, which correspond to the sequence of attribute selections made by the developer in 112. This expression 122 is then parsed by back-end algorithm 123 in 27. Next, program control 124 in 123 generates OHDS 68 in structure 104 (U.S. Pat. No. 6,279,005), which is used in the construction of compiled files 28.

In the new art, program control 132 in 27 captures selections made by the developer in new interface 130, and stores these selections as meta-query data in structure 128, which can be used either for creating runtime list menu 6 in 5 as well as for generating OHDS 68 in 104. The improved program flow of 132 is graphically depicted in the next figure in this series, FIG. 8b. Mapping algorithms 132 in 27 capture and transfer selections made by the developer in the new interface 130 directly into structure 128. Furthermore, interface 130 stores this meta-query data according to the new improved BAR format 135, which was recently disclosed with the discovery of the binary attribute relation or BAR, a new database abstraction derived from the BAR query, a primitive retrieval operation that has single input and output attributes or channels. The BAR and BAR query are new database concepts, and—more importantly—new techniques, which have greatly reduced the complexity of the new mapping algorithms 132 in 27, thereby making them easier to maintain.

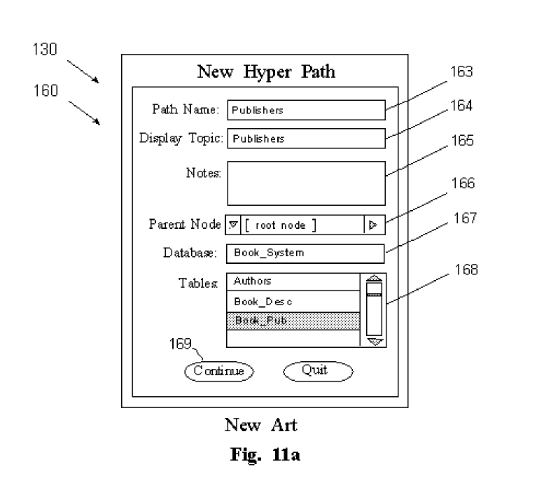

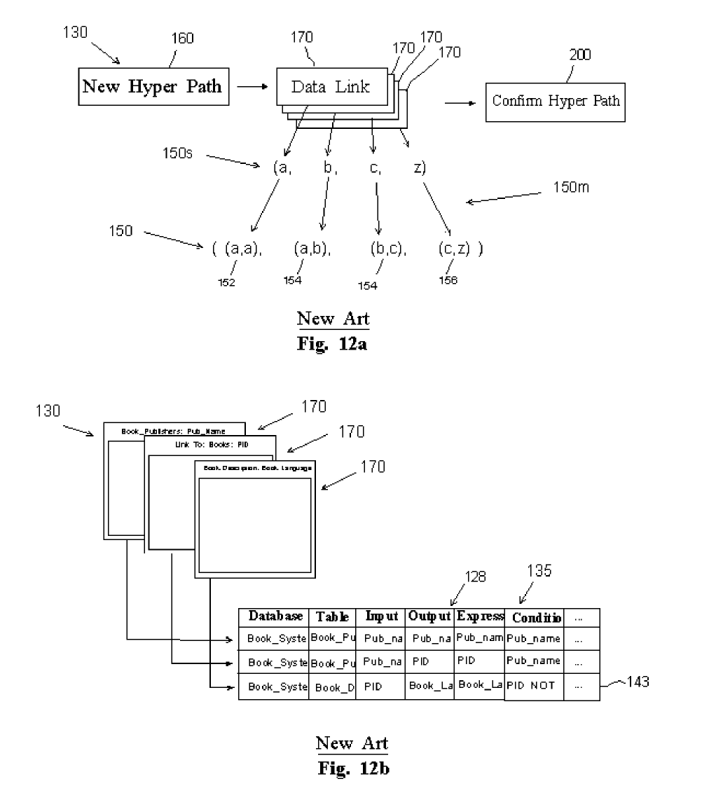

In the next two figures, the new and prior format of meta-query structure 128 is graphically displayed. The prior format 126 of structure 128 is depicted in FIG. 9a. The old format has a one-to-one correspondence with the Table Source fields in 114 of the prior interface 112, with Display Column 116 and Link Column 117 in 114 as 116a and 117a attributes in 128. In contrast, the new format 135 of 128, depicted in FIG. 9b, presents fields which are based on the recent teaching on the BAR and the BAR query, which essentially focuses on a pair of input and output attributes, and which allows for an alternative symbolic expression to the BAR chain, a Short form, which will be presented shortly in FIG. 12a.

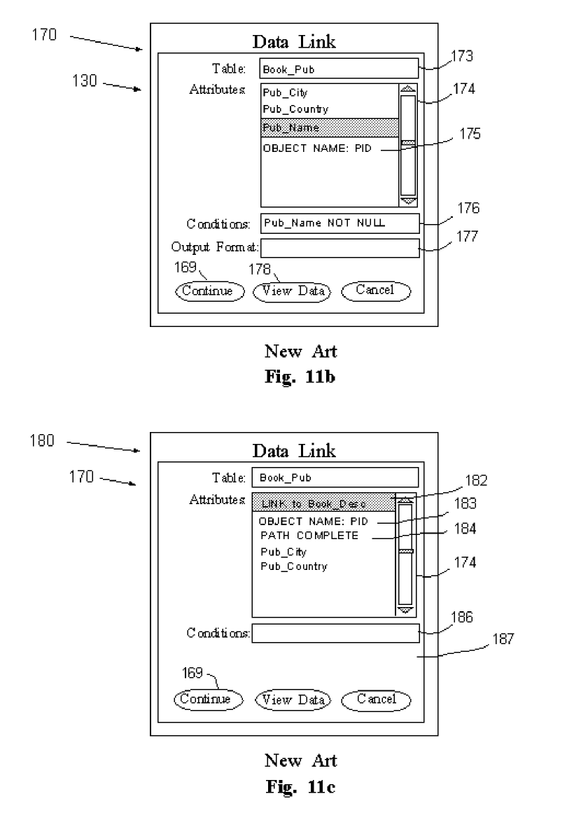

The next two figures, FIGS. 10a and 10b, show, in notation, the binary attribute relation or BAR and its expansion into the BAR chain, the topic for this new disclosure. The BAR was recently disclosed by Zellweger as a logical relationship between two database attributes, which represents a primitive data relation used in the construction of the content menu 5. The BAR query, a primitive retrieval operation—having a single input and output channel—is responsible for exposing this data relation. Together, the BAR abstraction and the BAR query provide the empirical tools which have led to the discovery of the BAR chain and its rules. There is a mathematical symmetry to all three of these concepts, and this symmetry has contributed to the incremental discovery of each one.

The BAR represents a pair of attributes drawn from the same database table. In notation, BAR 145 is graphically depicted in FIG. 10a. Each element in 145 corresponds to an input and output channel of the BAR query. One position, 147, depicts input; the other, 148, output. When this pair of elements in 145 is applied to the BAR query, another primitive in the relational model is exposed, the binary attribute data relation or BADR disclosed by 61/154,533. The latter, as mentioned above, is the essential building block for content menu 5, as well as for the knowledge representation it depicts, the database taxonomy. Thus, BAR 145 represents both an abstract concept, which describes a logical relationship between two attributes, and an operational formula, which represents meta-query data used to capture data relations. Given the mathematical foundation of the relational database, and the mathematical nature of the device that models it, it is fitting that BAR 145 would reveal such a concise pattern of details about data and data relations in the relational model, an area of research which, until now, has remained unchartered for a variety of reasons, which will be addressed shortly.

In the next figure, the notation in FIG. 10b depicts BAR chain 150, the new art introduced by this disclosure. In this expression, each pair of attributes in 145 corresponds to a link in a chain of interrelated BARs in chain 150. From this perspective, BAR chain 150 provides the framework for exposing the patterns and rules on the pairing of attributes in 145. In turn, BAR 145 is responsible for exposing the pattern of links in BAR chain 150, where the output from one BAR or link provides input for the next link. In this manner, all three of these concepts—BAR 145, BAR chain 150, and the BAR query—all work together, as mentioned earlier, to expose each others' distinctive identity.

The rules that govern the formation of BAR chain 150 are based primarily on the fact that the relational model employs two different types of attributes. As mentioned earlier in this disclosure, attributes in this model are either conceptual 48b—where the data describes something about the entity—or they are operational 48a, where the data serves as value-based links between two tables or entities. However, this functional distinction between describing and linking attributes and data is ambiguous because no matter how an attribute is declared in the schema, there are times when primary key data output can be descriptive in nature, as the reader will see shortly. Furthermore, the BAR query treats all input data operationally as value-based links, based on how it, and all retrieval operations for that matter, rely on pattern matching to accomplish its objectives. This confusion—where functionality and usage overrides schema declarations—can and will be cleared up, but this can only be done when viewing attributes in terms of the syntax of BAR chain 150.

The BAR chain 150 syntax reveals three distinct types of links: a source link 152, a destination link 156, and one or more optional branching links 154. In turn, each link, regardless of its syntax either serves up descriptive data-topics for a list menu in 5, or it manages value-based data links As a source link 152 always treats its attributes—regardless of its schematic declaration—in a strictly pragmatic fashion, as something which can describe an entity, or as something that the end-user can recognize as relevant information about it. For strictly practical reasons, namely impurities in the database, source link 152 represents a reflexive pair of attributes 145, where specially designed selection conditions on the input filter out impurities. From the end-users' perspective, the attribute in a source link is typically a conceptual one, but it can also be a primary key 48a, say in the case where a serial number or numeric product code could be used to describe an entity. Therefore, source link 152 always refers to a single attribute whose data provide “descriptive” data-topics, regardless of the schematic declaration.

The last link in a BAR chain 150, identified as a destination link 156, also has a distinctive pattern: it employs a single primary key 48a, or a composite of attributes that identify each unique row or tuple in a database table, as an output element 148 in BAR 145. In this capacity, the output element, a primary key 48a, functions in its traditional system role, as a link to a unique row or tuple that becomes the focal point for the creation of an information object window.

All other links in BAR chain 150 depict branching link 154. These links, as disclosed earlier, represent a pair of attributes (145) which are drawn from the same database table, where element 147 serves as meta-query data for an input attribute, and element 148 as meta-query data for the output of the BAR query.

In branching link 145, the patten of elements in BAR 145 is different for conceptual and operational attributes. Conceptual attributes and operational attributes whose data “describe” an instance of an entity or an information object (for example, data from a primary key being used as a “Object Name”), alternate between adjacent links, first appearing in the output position 148 and then in the input position 147 of the next link of 150.

When operational attributes are used in their traditional, system role for linking two tables, foreign and primary keys pair off between adjacent links, between output 147 in one link 145 and input position 147 in the next. This pairing of primary and foreign keys across tables can occur across branching links and between the last branching link and its successor, destination link 156.

The BAR chain 150, together with the BAR query, lays out the complexity of attribute roles in the relational model in plain view. The difference between attribute declarations in the schema and their actual usage in a database application can now be inspected and analyzed in a systematic fashion. This affords the opportunity to discover the syntactical rules that govern the formation of the BAR chain and the pairing of attributes in its links Having identified these rules, the inventor has applied these newly discovered rules to the functionality of the developers' interface art, by embedding them into the types of options that are displayed to the end-user, as he or she navigates over target database schema to capture a sequence of meta-query data.

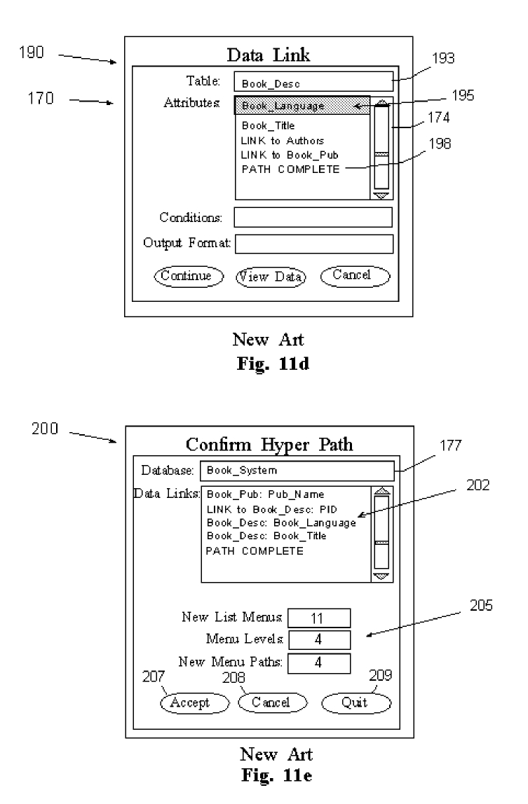

The new developer interface is presented over a series of figures, FIGS. 11a through 11e, that portray an example of a navigation sequence taken by a developer and used to capture meta-query data. Each menu interface in this series guides the developer in this navigation by displaying only options that are consistent with BAR chain 150. After a brief introduction, a summary of these rules and how they impact the type of options that are shown to the developer will be presented.

The first menu in the new developers' interface 130, New Hyper Path 160, is displayed in FIG. 11a. The end-user employs this interface to declare a new data-topic segment in authoring system 27. First, the developer provides the segment a name in field 163. Next, he or she adds a constructed-topic for the segment, a character string 164 that will appear in a list menu 6 of 5 as a selectable topic. Any comments or notes about this new segment can be provided in text field 165. At 166, the developer navigates through an existing OHDS 68 in 104, using a built-in content menu 5 in 27, to identify a parent node in OHDS 68 in for this new segment. An external database name, such as 35, can be selected from a drop down list of database names in 167.

Upon selecting an external database 35, the authoring system manages the integration of communication software and contact information in 27 in order to establish a seamless software connection to database 35. Once an external database connection is established, a list of the database's tables is displayed in scrolling region 168. To start navigating over its schema, the developer selects a table name in 168, followed by selecting Continue button 169.

Next, interface 130 displays Data Link menu 170, depicted in FIG. 11b. It is important to note that there is a direct correspondence between each Data Link 170 in the developers' navigation of 130 and each BAR link 145 in a Bar chain 150. This one-to-one correspondence will be shown graphically in FIG. 12a.

In field 173 of 170, labeled Table, is the name of the previously selected table name. Directly below this field is scrolling region 174 which displays the table's attributes as selectable list items. The first time a Data Link interface 170 is displayed in 130, all of the table's conceptual attributes 49 are displayed. And, none of its operational attributes 48 (and the relational means to navigate to other tables) are displayed, except for a descriptive label on the primary key that will be explained below. Interface 130 controls the attribute display in this manner, and—in order to conform with the syntax of BAR chain 150, thereby enabling the options in first Data Link 160 to directly correspond to elements in source link 152 of BAR chain 150.

After selecting an attribute in 174 and Continue button 169, a new Data Link 170, displayed in FIG. 11e, redisplays the remaining unselected attributes in Book_Pub, while, at the same time, introducing its new treatment of the primary key. Data Link 180 now typically corresponds to a branch link 154 in BAR chain 150, as it now treats a primary key 48a in three different ways:
As an attribute which describes an entity, in the NAME: PID″ entry 183.
As an attribute paired with a foreign key, in the “LINK to Book_Desc” item 182, which enables the next Data Link 170 to display the contents of “Book_Desc” table 40.
As an output attribute in a destination link 156, which enables content menu 5 to link to a database record or tuple with the “Path Complete” entry 184, thereby concluding the session by displaying the final menu in 130, a confirmation menu 200.

In remaining figures in this series, FIGS. 11c through 11e show how this new interface art applies the rules that govern the formation of links in the BAR chain 150 to determine the primary key 48a display and to make each Data Link 170 context sensitive. These rules are based on the type of attribute: conceptual versus operational; and how interface 170 makes them available as options in the link-building phase of BAR chain 150. As one would expect, the BAR chain 150 starts with a source link 152, terminates with a destination link 156, and can include one or more branches 154. A brief summary of these rules can be found in Table 1 below.

TABLE 1

| | Data Link as Source | Data Link as Branch |
|---|---|---|
| Attribute Types | | |
| Displayed: | | |
| Conceptual | All such attributes. | Any unselected attributes. |
| Operational: | ‘Object Name’ clause. | ‘Object Name’ clause. |
| Primary Key | | ‘Link to’ clause. |
| | | ‘Path Complete’ clause. |
| Operational: | Never | Never, but implied by the ‘Link |
| Foreign Key | | to’ clause. |
| Next Interface: | Data Link as Branch | Data Link as Branch or |
| | | Confirm. |

Across the top of Table 1 are labeled columns that refer to the Data Link 170 as either a source link 152 or a branch link 154 in a BAR chain 150. These link positions dictate how conceptual and operational attributes are displayed in 174 of 170, and which menu interface in 120 comes next, either another Data Link 170 in the case of source link 152, or another Data Link 170 or a Confirmation menu after branch link 154 when ‘Path Complete’ is selected.

The first Data Link 170 in 130 only displays conceptual attributes, and nowhere in interface 130 does menu 170 ever display any foreign keys. Also, any subsequent table menu 170 will only display the unselected conceptual attributes. As noted earlier, this menu treats the primary key differently, as either an attribute which manages data that describes an entity, or which links to an information object window or to another table. To signify this describes usage, menu 170 uses the term “Object Name” in the list entry to identify this role, the “Path Complete” to signify a link to an object window, and the “Link to” entry to signify a link to another table.

Before moving on to the next figures in this series, we should point out some other details about Data Link 170 in FIG. 11b. Directly below region 174 in 170, there are two input fields. In field 176, the developer can supply an optional conditional clause which will be added to the BAR query to improve the precision of the retrieval operation. The developer can also supply output format details in field 177 which are applied to the output channel of the BAR query to improve the appearance or the clarity of the output data. Directly below these fields are the command buttons. By selecting View Data button 178, the developer can view a pop-up list of data values of the current attribute in region 174. And lastly, the developer triggers the appearance of next menu in the sequence by selecting the Continue button 169, which in case is determined by the item selected in 174, refers to the same table and would display all the same attributes minus the selected Pub_Name entry.

In the next figure in this directed sequence, another Data Link 170 depicted FIG. 11e is displayed. It references the same Book_Pub table 60, but refreshes region 174 in order to show a new set of options which correspond to a branch link 154 in 150. In keeping with this rule-based implementation, region 174 in 180 now displays all the conceptual attributes 49 in the current table, minus any attributes selected in the previous menu 130.

Other context-sensitive differences between 130 and 180 can be seen in the area directly below region 174. When the “LINK to” item is selected, Data Link interface 170 filters out the Output Format label and field 177 display in 160, as entry 182 represents operational data which works at the system level, and its display is not relevant. However, the Conditions label and field 186 remain, so that the developer can supply additional selection conditions by hand to the set of meta-query data, if he or she chooses to.

After selecting “LINK to” entry 182 and the Continue button 169 in 180, the next Data Link interface 170, identified as 190 in FIG. 11d, displays “Book_Desc” 40 attributes in region 174, according the rules outlined in Table 1. In effect, the developer selects the “LINK to” entry to navigate over the database schema and to capture this navigation directly in the form of meta-query data, a prominent new feature in this disclosure. Program control in 27 manages the pairing of foreign and primary keys amongst the tables in a database system, thereby enabling the developer to freely navigate over the schema, as the database architect intended.

When the PATH COMPLETE item 198 and the Continue button in 190 are selected interface 130 displays menu 200, the Confirm Hyper Path display shown in FIG. 11e. Here the database name is display in field 177 and scrolling region 202 displays a list of the data-topic attributes and link attributes that constitute the hyper path. The list is chronologically ordered by the sequence of Data Link menus selected by the developer in interface 130. Each data-topic source is presented in a table:attribute format. Each link is introduced by a “LINK to” prefix along with the destination table name and the key that binds the two tables. While the OBJECT NAME option was not used in this example, if it were it, too, would be included by name in the list along with the primary key.

Lastly, the Confirm Hyper Path interface also displays summary information about the new “hyper-path” created by the developer's navigation in region 205. At this point, the developer can select the Accept button 107 to capture the meta-query data and store it in structure 128 managed by 27. Otherwise, the Quit button 208 would close interface 170, and the Cancel button 209 would return the developer to the previous Data Link interface 170.

This concludes the disclosure of the preferred embodiment of new interface 130. Alternative embodiments of 130 include other types of graphical displays, such as tree views and area maps, to represent database schema 35 as a navigation surface, which enable developers to select a sequence of tables and attributes and to capture this sequence in a symbolic expression, like BAR chain 150, which can be used as meta-query data.

The next two figures, FIG. 12a and FIG. 12b, show the relationships between the menus in the new developers' interface 130 and BAR chain 150, and between the sequence of menus in 130 and the structure which stores and manages meta-query data.

The relationship between the sequence of Data Link menus 170 in 130 and BAR chain 150 is highlighted by FIG. 12a. Interface 130 starts with New Hyper Path menu 160 and concludes with Confirm Hyper Path menu 200. In between these two menu states, there are one or more Data Link menus 170. As mentioned earlier, each menu 170 corresponds to a link in BAR chain 150. The short form of BAR chain 150 is displayed at 150s. Each element in 150s corresponds to an attribute entry selected in region 174 of 170. Algorithm 150m in the mapping algorithm 132 of authoring system 27 transforms each element in short form 150s into a pair of elements in BAR link 145 of the long form BAR chain 150, based on the patterns and rules presented earlier in the discussion of FIG. 10b.

The next figure in this series, FIG. 12b, highlights the correspondence between each Data Link 170 and meta-query data stored in structure 128 according to the new format 135. Program control 150m in mapping algorithm 132 of the authoring system can either establish an embodiment of BAR chain 150 in structure 128, or 150m can establish each link in chain 150 from short form meta-query data (150s) in structure 128 at runtime prior to extracting data and data relations from 35, depending upon the system optimization and configuration.

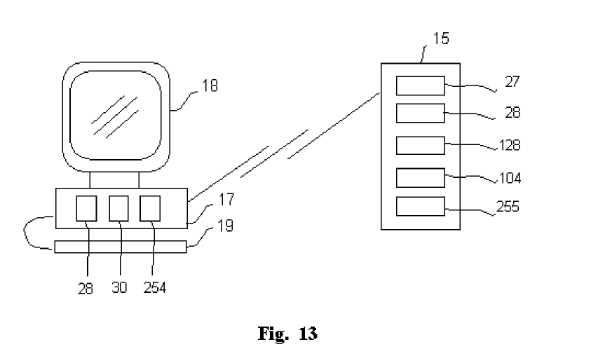

The next figure shows the architecture of the client/server apparatus and the software components of the new art that are responsible for processing compiled and runtime list menu 6 in content menu 5, based on BAR chain 150. In FIG. 13, the client computer 17 has a software cookie 254 that manages data on each end-user session. Browser software 30 communicates with server 15 to request menu data in order to build and manage content menu 5 on 17. In turn, server 15 builds and maintains menu data 28 based on meta-query data in 128 that conforms to one or more BAR chains 150. Server 15 also manages client session information with software routines 255 that provide a centralized overview of the content menu sessions.

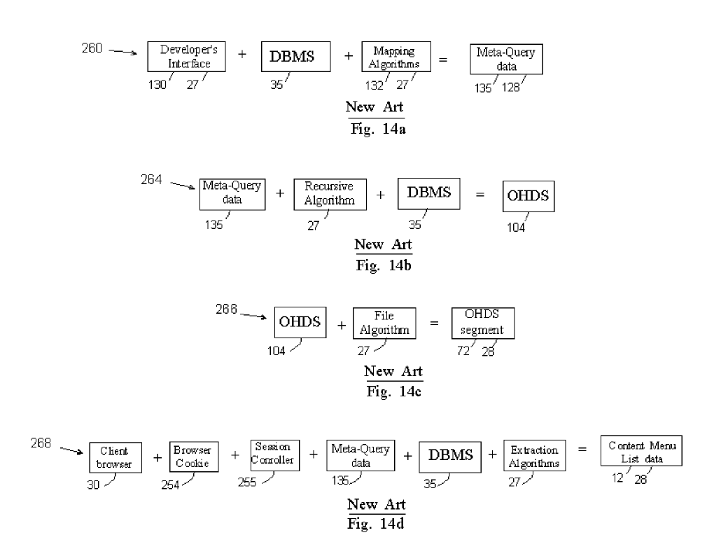

In the final series of figures, FIGS. 14a through 14d display the program flow of software components that are used to construct compiled and runtime list menus 6 in 5, according to meta-query data in structure 128, which employs the new format 135, based on BAR chain 150.

The first figure of this series, FIG. 14a shows the software components that are responsible for capturing meta-query data and storing it in structure 128. This includes the new developers' interface 130 and mapping algorithms 132 in 27 introduced by this disclosure. Together, interface 130 and program control 132 enable an end-user or a developer to navigate over target database 35, to select a logical series of attributes, and to store them as meta-query data in structure 128 in a format that characterizes BAR chain 150.

The next figure in this series, FIG. 14b shows the program flow of the software components which generate compiled menu data files 28. This process starts with the construction of OHDS structure 68 in database 104, using meta-query data in structure 128 and the recursive algorithm in 27, which retrieve data-topic lists from target database 35 and then apply them systematically to OHDS 68 by adding each new output list to a leaf node. This pattern of construction is similar to the tree-growing methodology described by Biggs that mimics the depth-first search. The recursion is based on the sequence of meta-query data in the BAR chain. Upon the completion of the process, file mapping algorithms in 27 traverse OHDS 68 in 104, to compile one or more compiled menu data files 28, where each file contains a network segment of OHDS 68, like node 72 and its children in FIG. 5.

The last figure in this series, FIG. 14d, shows the program flow for constructing runtime menu data files 28. This program flow starts with a request for menu data made by browser software 30 on a client 17. This request is based on session information maintained in client cookie 254 and derived from the current active list menu in 5. Session controller 255 on server 17 receives the client request and dispatches it to retrieval routines managed by 27. The retrieval routines in 27 fetch meta-query data from structure 128 to generate the next list menu 6 in 5. This enables these routines to extract a specific data-topic list from target database 35 that can be formatted as menu data in file 28. When these operations are completed, this routine sends the newly generated runtime file 28 back to software 30 on 17.

### GLOSSARY

BAR query—any primitive retrieval operation which has a single input and output channel, including alternative embodiments of a predefined query language interface, such as program control or a program interface on a data system which has a single input and output channel.

BAR or binary attribute relation—a new concept which identifies the logical relationship between two pools of data in a data system, which is expressed at the data level by a retrieval operation like a BAR query or by an program interface that has a single input or output channel. This term can also be used to describe a logical relationship created by a retrieval algorithm between two pools of data in one or more systems that are used to manage data, including file and directory systems.

conceptual attribute—any pool of data which describes a property of an entity that is modeled by a data system and that can be used to furnish data-topics for a content menu.

conceptual data—a data value that can describe a property of an entity that is modeled by a data system.

constructed-topic—a topic in a list menu of a content menu that was supplied by a menu developer.

content menu—a graphical user interface (GUI) consisting of one or more nested list menus, or equivalent isomorphic structures such as a tree-view, which depicts data-symbols and their relations in a data system in the form of a database taxonomy.

database—a data system composed of one or more pools of data which constitute an entity, and where this system supports one or more entities by supporting integrated retrieval operations.

data object—a pool of data in a data system. In a data system like a relational database, each table attribute or field would represent a data object.

data structure—the most basic data system which manages data on a computer according to a predefined arrangement of data values.

data-symbol—a data value drawn from a pool of data and displayed in a list menu of a content menu.

database taxonomy—the knowledge representation of data and data relations in a data system or database that is made available to the end-user by the content menu GUI.

data-topic—any data value drawn from a pool of data in a data system which can be displayed in a content menu because it is meaningful to an end-user who would be navigating this menu structure to locate information.

data system—a computer software system that is used to manage a collection of data. Such systems can range in scale from the simplicity of a computer file or directory system—consisting of uniform divisions, subdivisions, and fields within those subdivisions—all the way up to the complexity of the relational database management system (RDBMS).

hyper-path—a data path that can be represented by a BAR chain.

meta-query data—any data that is selected or supplied by a developer and stored on a computer and that can be used to construct a BAR query.

meta-symbol—an aspect of a physical symbol on a computer that enables a software system to deploy the symbol in a logical operation, such as pattern matching, or to identify the symbol as a member of a pool of data, with the former representing its mechanical value and the latter its constructed type.

operational attribute—a pool of data in a data system (or an attribute in a relational table) that has been declared as a primary or a foreign key.

operation data—any data value that can be used to linkage within a structure. In the relational database, operational data is represented by any attribute that has been declared in the schema as either a primary or foreign key.

primitive data relation—the data mapping between two pools of data in a data system derived from a BAR query which represents a “one-to-one” or a “one-to-many” relationship between a single input condition value—the one—and its output, arbitrarily one or many, depending upon the output.

### CONCLUSION

This concludes the description of an embodiment of the invention. While the preferred embodiment of this invention was a relational database, alternative embodiments include data from other data models, in other data structures, and even in system files. Therefore, the foregoing description of the embodiment of the invention has been presented for the purpose of illustration and description. It is not intended to be exhaustive or limit the invention to the precise form disclosed. Many modifications and variations are possible in light of the above teaching, and in light of the fact that the subject matter here, the BAR chain is a precise, compact mathematical expression which can represented in a more complex manner that could embed unnecessary redundancies, either in the BAR chain itself or the mapping algorithm responsible for retrieving data and data relations from an external data file. Therefore, the scope of the present invention is not intended to be limited by this detailed description, but rather by the claims appended hereto.

Having described an embodiment of the invention I claim:

1. A computer software system used to capture and to store a series of meta-query data which is responsible for generating a network segment of data and data relations from an external data file consisting of:
a developers' interface which enables an end-user developer to navigate over the structure of said external data file and to capture said series of meta-query data,
an algorithm which provides the means for generating said network of data and data relations from in said external data file by said series of meta-query data,
whereas, said computer software system provides the means for generating a list menu for a content menu which can be used by a nontechnical end-user to view the contents of said external data file.

2. The computer software system of claim 1 wherein said computer software system is implemented in at least one computer language.

3. The series of meta-query data of claim 1 wherein said series of meta-query data is at compatible with the rules and properties of a BAR chain, including a short form of said BAR chain.

4. The series of meta-query data of claim 1 wherein a basic unit of meta-query data in said series of meta-query data is compatible with retrieving a list of data from at least one data model, one data structure, and one record-oriented file.

5. The basic unit of meta-query data of claim 4 wherein said basic unit of meta-query data is logically related to at least one other basic unit of meta-query in said series of meta-query data.

6. The developers' interface of claim 1 wherein said developers' interface provides the means for guiding said end-user developer in capturing said series of meta-query data by filtering out irrelevant options related to the structure of said external file, and by highlighting context sensitive options related to the structure of said external file, in accordance with the properties and rules of said BAR chain.

7. The list menu in said content menu of claim 1 wherein said list menu for said content menu is generated at runtime by a request that was initiated by an action taken by said nontechnical end-user.

8. The list menu in said content menu of claim 1 wherein said list menu for said content menu is compiled and generated at a scheduled time.

9. The developers' interface of claim 1 is implemented using at least one graphic user interface technique.

10. A computer software system for capturing and storing a series of meta-query data which is responsible for generating a network segment of data and data relations from an external data file consisting of:
a developers' interface for navigating over the structure of said external data file and to capture said series of meta-query data,
an algorithm for generating said network of data and data relations from in said external data file by said series of meta-query data,
whereas, said computer software system for generating a list menu for a content menu which can be used by a nontechnical end-user to view the contents of said external data file.

11. The computer software system of claim 1 wherein said computer software system is implemented in at least one computer language.

12. The series of meta-query data of claim 1 wherein said series of meta-query data is at compatible with the rules and properties of a BAR chain, including a short form of said BAR chain.

13. The series of meta-query data of claim 1 wherein a basic unit of meta-query data in said series of meta-query data is compatible with retrieving a list of data from at least one data model, one data structure, and one record-oriented file.

14. The basic unit of meta-query data of claim 13 wherein said basic unit of meta-query data is logically related to at least one other basic unit of meta-query in said series of meta-query data.

15. The developers' interface of claim 1 wherein said developers' interface provides the means for guiding an end-user developer in capturing said series of meta-query data by filtering out irrelevant options related to the structure of said external file, and by highlighting context sensitive options related to the structure of said external file, in accordance with the properties and rules of said BAR chain.

16. The list menu in said content menu of claim 1 wherein said list menu for said content menu is generated at runtime by a request that was initiated by an action taken by said nontechnical end-user.

17. The list menu in said content menu of claim 1 wherein said list menu for said content menu is compiled and generated at a scheduled time.

18. The developers' interface of claim 1 is implemented using at least one graphic user interface technique.
